(19) United States
(12) Patent Application Publication
(10) Pub. No.: US 2025/0332598 A1
(43) Pub. Date: Oct. 30, 2025

(54) Air Filter and Air Filter Assembly

(71) Applicant: MAHLE International GmbH, Stuttgart (DE)

(72) Inventors: Sven PETZNER, Welzheim (DE); Daniel EBERLE, Ludwigsburg (DE)

(21) Appl. No.: 19/191,709

(22) Filed: Apr. 28, 2025

(30) Foreign Application Priority Data
Apr. 29, 2024 (DE) 102024111978.0

(51) Int. Cl. B03C 3/155; B01D 46/00; B01D 46/42; B01D 46/52; B03C 3/66

(52) U.S. Cl. CPC B03C 3/155; B01D 46/0005; B01D 46/0032; B01D 46/4245; B01D 46/521; B03C 3/66; B01D 2279/50

(57) ABSTRACT

An air filter for an air filter assembly in an air conditioner is provided, in particular for filtering out particles, preferably pollutants, from air. The air filter contains a filter element with an electrically conductive layer. The air filter also has a housing that partially encompasses a housing interior into which the filter element is inserted. The air filter also has a terminal on the housing that can be contacted from outside the housing interior, which is made of an electrically conductive material and is connected to the conductive layer of the filter element.

### CROSS-REFERENCE TO RELATED APPLICATIONS

This application claims priority from German Patent Application No. 10 2024 111 978.0, filed on Apr. 29, 2024, the entirety of which is hereby incorporated by reference herein.

The present invention relates to an air filter for an air filter assembly in an air conditioner, and an air filter assembly containing such an air filter.

To obtain a pleasant and healthy air quality, contaminants such as particulate matter, noxious gases, hydrocarbons and nitrous oxides, as well as unpleasant odors must be removed from the air supplied to the passenger compartment of a vehicle. High levels of particulate matter in the ambient air have proven to be particularly problematic. In metropolitan areas the levels thereof are often above the prescribed daily levels.

Dust is normally removed from the air entering the vehicle interior through the air conditioner by an air filter, which contains a fibrous filter layer that removes particles in the air. This filter is crucial for the quality of the filtered air. There is very little installation space for such filters in modern air conditioners for motor vehicles. For this reason, they must exhibit a low flow resistance, such that they only generate slight pressure losses, in order that the desired amount of air can be conveyed into the vehicle interior.

In order to obtain a low flow resistance, the fibrous filter layer is normally open-pored, such that the mechanical filtering effect is relatively low. For this reason, conventional filters are electrostatically charged in the production process. This improves the filtering effect during operation. This also filters out very small particles, with a diameter of less than 0.3 μm, without noticeably increasing the flow resistance of the filter and thus the pressure losses.

Unfortunately, the filtering effect obtained from the electrostatic charge quickly diminishes as the filter ages and becomes clogged. Consequently, this electrostatic charge is most effective at the start of its service life. Depending on how polluted the air is, this decrease in the electrostatic charge can occur within just a few weeks or months.

It is therefore the object of the present invention to demonstrate new ways of developing the above air filters. In particular, an improved air filter is to be obtained, which makes use of the electrostatic charge explained above, resulting in an improved filtering effect over the entire service life of the filter element.

This is achieved with the subject matter of the independent claims. Preferred embodiments are the subject matter of the dependent claims.

The fundamental concept of the invention is to therefore incorporate a filter element in the air filter that has an electrically conductive layer with which the filter element can be recharged, i.e. reactivated. It is therefore proposed to attach an electrically conductive terminal to the air filter that is connected to the conductive layer of the filter element, and can also be connected to an external power source. Consequently, the conductive layer can be connected to a high voltage power source with which the filter element can be electrostatically charged. As a result, the effects of the electrostatic charge are not restricted to the start of its service life. This results in a filter element that remains effective over its entire service life.

In detail, the air filter obtained with the invention contains a filter element that has a filtering medium with which particles are filtered out of the air passing through it, and has an electrically conductive layer. The filter also has a housing that partially encompasses an interior space. The air filter has an electrical terminal on the housing for connecting to an external power source, which is made of an electrically conductive material and is connected to the conductive layer of the filter element inside the housing.

A preferred embodiment of the filter element has not only the conductive layer, but also at least one layer through which air can flow for filtering out particles. The conductive layer is preferably on top of the filtering layer. This conductive layer could also be on a separate substrate from the filtering layer. This has advantages if the conductive layer is made of activated carbon. In this case, the activated carbon can be attached to the substrate with an adhesive. This substrate is preferably a nonwoven.

The conductive layer preferably forms an outer surface of the filter element that is connected to the terminal. This simplifies and improves contact to the terminal.

In another preferred embodiment, the terminal is a spring contact, in particular in the form of a leaf spring. This allows for the terminal to be tensioned against the filter element with the conductive layer. This results in a particularly good contact between the terminal and the conductive layer.

The terminal is thus preferably pressed against the conductive layer on the filter element in the housing. The terminal thus forms a tensioning element. This also results in a particularly reliable contact between the terminal and the conductive layer.

The spring terminal is preferably made of, or contains, steel, in particular spring steel. This is an inexpensive means of obtaining a spring terminal like that described above.

In another preferred embodiment, the terminal is removably or permanently connected to the housing. It can also protrude from housing. The terminal can also at least partially seal a hole in the housing. All of these measures with which this preferred embodiment is obtained simplify assembly of the air filter and obtaining contact between the terminal and the conductive layer, in and of themselves or in various combinations thereof.

In another preferred embodiment, the filter element contains a filtering medium in the form of a pleated bellows on which the conductive layer is placed. In this case, the terminal is on at least one pleat, in particular the peak thereof. This type of filter element has a particularly large surface area, resulting in an efficient filtering of particles from the air with a comparatively low pressure drop in the air. This combines the advantages of the filter element obtained with the electrostatic charge with the advantages of a pleated filter element.

In another advantageous design, the filtering medium, or filtering layer of the filter contains a material that filters out particles, in particular aerosols, preferably with a diameter of 50 nm to 2.5 μm. This filtering material can preferably be or contain a nonwoven or a filter paper.

The conductive layer can preferably contain or be made of activated carbon. Consequently, not only particles, but also noxious gases and substances that generate odors can be effectively filtered out of the air flowing through the filter element. This activated carbon can be attached to a substrate, in particular with an adhesive. In this case, the substrate must be designed such that an electrical connection can be obtained between the conductive layer and the terminal. This is preferably obtained with a sufficiently thin layer forming the substrate.

There can also be an opening in the housing through which the filter element can be inserted. With this design, there is a deflecting element in the housing that pushes the filter element against the terminal when it is inserted. This ensures that the necessary contact is obtained between the terminal and the conductive layer when the filter element is replaced.

In another preferred embodiment, the filter element can be slid through the opening into the housing. With this design, the deflecting element reduces the cross section of the housing interior. This presses the filter element against the terminal when it is inserted into the housing.

The deflecting element can preferably form a wedge. This presses the filter element increasingly toward the terminal as it is inserted into the housing. This ensures that the necessary electrical contact is obtained between the conductive layer and the terminal once the filter element has been fully inserted into the housing.

The deflecting element can be attached to the housing or integrated therein. This significantly reduces production costs for the air filter.

The interior cross section preferably diminishes along the deflecting element in the insertion direction. This presses the filter element against the terminal as it is inserted in the housing. This design of the housing interior is obtained with the wedge-shaped deflecting element described above.

The invention also relates to an air filter assembly for an air conditioner, in particular for filtering out particles, preferably pollutants, from the air. There is a flow path for the air through the air filter, as well as an ionizer that contains at least one discharge electrode and at least one counter electrode for generating ions in the air flow.

The air filter assembly also contains an air filter downstream of the ionizer in the flow path, such as that described above and obtained with the invention. The above advantages of the air filter obtained with the invention also apply to the air filter assembly.

The air filter assembly also contains a high voltage source with an electrical pole and counter pole for generating high voltages, in particular from 5 kV to 15 kV, between them. The pole is electrically connected to the at least one discharge electrode in the ionizer. The counter pole is electrically connected to the at least one counter electrode in the ionizer and the conductive layer of the air filter. The at least one discharge electrode therefore has the electrical potential of the pole. The at least one counter electrode and the conductive layer have the electrical potential of the counter pole. In a simplified version, the counter electrode and conductive layer are connected to the electrical potential of the counter pole, and the discharge electrodes are connected to the electrical potential of the pole.

In a preferred embodiment, at least one counter electrode contains or is an electrode plate, preferably located between two discharge electrodes. This improves the ionization effect of the ionizer.

Particularly efficient ionization is obtained with at least three discharge electrodes and two electrode plates placed in the flow path, in an alternating sequence and spaced apart from one another, transverse to the flow path.

In a preferred embodiment of the air filter assembly obtained with the invention, the electric counter pole is connected by a wire to the terminal. In this embodiment, the wire is connected to the terminal on the air filter by soldering or crimping. This simplifies construction of the air filter assembly.

A negative charge can be applied to at least one discharge electrode. The counter electrode then forms the ground in this version. To generate a so-called corona discharge, a negative direct current is preferably applied, because a negative corona discharge is more stable and results in higher corona flows than a positive corona discharge.

The discharge electrodes preferably comprise at least one electrode rod, from which at least one tip protrudes toward the second electrode, preferably against the direction of flow, for generating ions. Preferably, at least two, ideally numerous, electrode tips protrude from the at least one electrode rod.

The electrode tips ideally protrude against the direction of flow. This generates an extremely strong electrical field with a field strength of 10 kV/mm to 40 kV/mm, facilitating the generation of numerous ions and therefore the charging of particles in the air flow. There are preferably numerous electrode tips, spaced apart from one another along the electrode rod. This enables the generation of ions over the entire cross section of the flow path.

In another preferred embodiment, the at least one electrode rod extends, particularly in a straight line, in a direction transverse to the direction of flow in the flow path for the air.

At least two, preferably more, ideally all, of the electrode rods are spaced apart in a direction orthogonal to the direction of extension, at a distance of 20 mm to 60 mm, preferably 25 mm to 35 mm. This ensures that the pressure drop generated in the air by the ionizer remains relatively low.

Ideally, at least two, preferably more, particularly all, of the electrode tips are spaced apart along the rod at a distance of 1 mm to 30 mm, preferably 5 mm to 9 mm. This results in a particularly strong ionizing effect.

The electrode tips can ideally be arranged in a grid in the flow path. This results in an improved field line formation for the corona field in the flow path.

In an advantageous design, at least one of the electrode tips is tapered, in particular conically, ideally counter to the direction of flow. This is preferably the case for many of the electrode tips, ideally all of the electrode tips.

The effect of the polarization exerted by the electric field on the filter element depends on the intensity of the electric field generated by the ionizer. A stronger electric field results in a greater polarization effect. For this reason, the electrodes in the ionizer should be as close as possible to the entry surface of the filter element. In another preferred embodiment, the distance between the ionizer and the filter element is therefore no greater than 30 mm, preferably no greater than 7 mm.

The at least one electrode and/or counter electrode is preferably made of steel, in particular stainless steel.

In an advantageous design, there can be a switch between the terminal and the counter pole for disconnecting them. This allows for the electrostatic charging of the filter element to be activated and deactivated as needed, and thus controlled in a targeted manner.

Other important features and advantages of the invention can be derived from the dependent claims, drawings, and the descriptions of the drawings.

It is to be understood that the features described above and explained below can be used not only in the given combinations, but also in other combinations, or in and of themselves, without abandoning the framework of the present invention.

Preferred exemplary embodiments of the invention are shown in the drawings and shall be explained below in greater detail, in which the same reference symbols are used for the same, similar, or functionally identical components.

Therein, schematically:

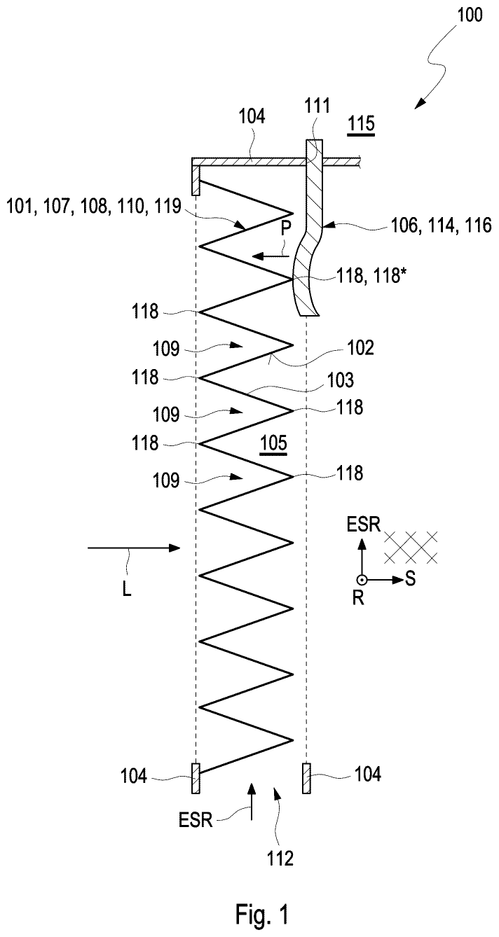

FIG. 1 shows a longitudinal section of an exemplary air filter obtained with the invention,

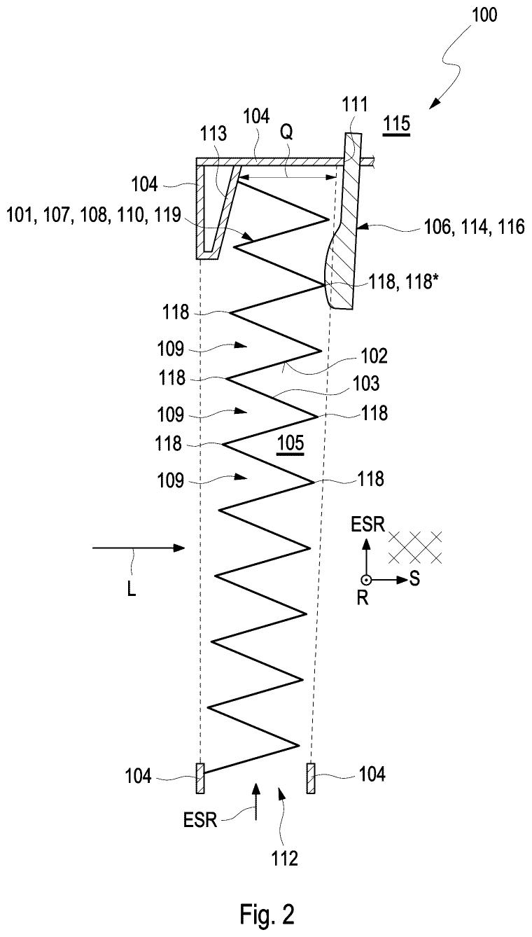

FIG. 2 shows a variation of the example shown in FIG. 1, and

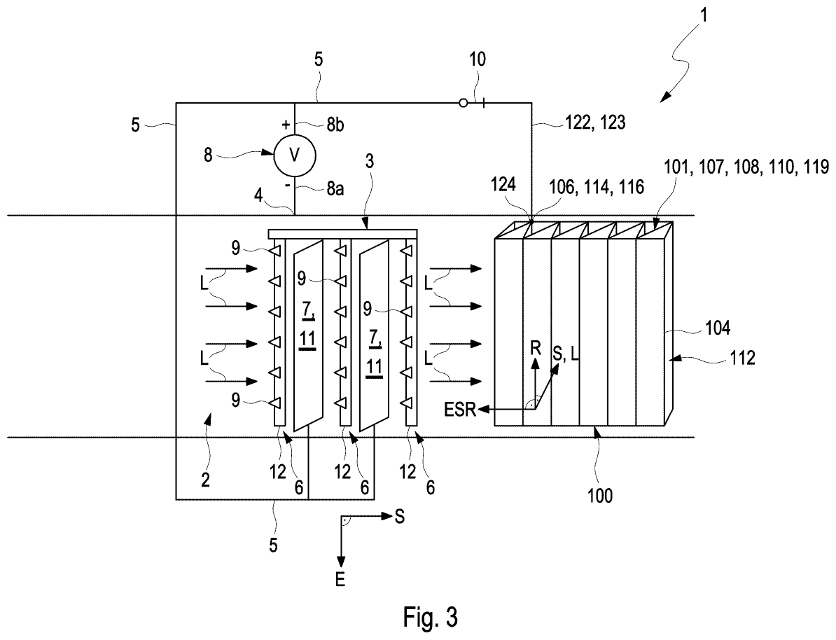

FIG. 3 shows an air filter assembly obtained with the invention, containing an air filter obtained with the invention.

FIG. 1 schematically illustrates a longitudinal section of an exemplary air filter 100 obtained with the invention. The air filter 100 contains a filter element 101 with a filtering medium 107, which has an electrically conductive layer 103 on its outer surface 102. This layer 103 can be placed over all or part of the entire outer surface 102.

The conductive layer 103 can be made of activated carbon. The air filter also has an open housing 104, partially encompassing an interior 105 through which air L that is to be filtered flows in a flow direction S.

This flow direction S is perpendicular to the drawing plane in FIG. 1. The filter element 101 can be replaced in the housing 104. The housing 104 can have an opening 112 for this, through which the filter element 101 can be inserted into the housing interior 105.

The filter element 101 in FIG. 1 is slid, in particular, in the insertion direction ESR, through the opening 112 into the housing interior 105. FIG. 1 therefore shows a longitudinal section of the air filter 100 cut along the insertion direction ESR.

The air filter 100 in FIG. 1 also has a terminal 106 on the outside of the housing 104 made of a conductive material. This conductive material is preferably a metal. The terminal 106 bears on the conductive layer 103 of the filter element 101 such that it is electrically connected thereto. The terminal 106 is a spring component 114, basically forming a leaf spring. The material forming the terminal 106, or the spring component 114, can be steel, preferably spring steel.

The terminal 106 shown in FIG. 1 can thus be tensioned against the conductive layer 103 on the filter element 101 in the housing 105 in the direction indicated by the arrow P. The terminal 106 therefore also acts as a tensioning element 116.

In this example, the terminal 106 is permanently attached to the housing 104, e.g. with an adhesive or threaded fastener, and extends both into the housing interior 105 as well as away from the housing 104 into the exterior 115 of the air filter 100. The terminal 106 can also seal a hole 111 formed in the housing 104.

The filter element 101 can contain a filtering medium 107, schematically indicated in FIG. 1, which forms a pleated bellows 108 with numerous pleats 109, on which the conductive layer 103 is placed. The terminal 106 is on one of the peaks 118 of one of the pleats 109 forming the bellows 108. The filtering medium 107 contains a filtering material 110 with which particles, in particular aerosols with a diameter of 50 nm to 2.5 μm, can be filtered out. The filtering material is preferably made of, or contains, a nonwoven or filter paper. In this example, the filter element 101 contains a filtering layer 119, on which the conductive layer 103 is placed. The conductive layer 103 forms an outer surface 102 for the filter element 101, to which the terminal 106 is connected. The conductive layer 103 could also be on a different substrate (not shown) from that for the filtering layer 119, which could be between the conductive layer 103 and the filtering layer 109. The conductive layer 103 can contain or be composed of activated carbon. In this case, the activated carbon could be glued to the aforementioned substrate. As shown in the illustration, the terminal 106 is on a peak 118 of one of the pleats, on the conductive layer 103 forming the outer surface 102. In another version, the conductive layer 1103 can also be between the filtering layer 119 and the substrate, such that substrate forms the outer surface 102.

FIG. 2 shows a variation of the embodiment in FIG. 1. For that reason, only the differences to that in FIG. 1 shall be explained below. There is a deflecting element 113 in the housing interior 105 in this version, with which the filter element 101 is pushed against the terminal 106 when it is inserted into the housing interior 105. This ensures that when a replacement filter element 101 is inserted, the necessary contact by the terminal 106 to the conductive layer 103 on the filter element 101 is reliably obtained. This deflecting element 113 can be attached to the housing 104 or formed as an integral part thereof. The deflecting element 113 could also be formed separately, and then be releasably or permanently attached to the housing 104.

The filter element 101 in FIG. 2 can also be slid into the housing interior 105 through the opening 112 in the insertion direction ESR. The interior cross section Q of the housing interior 105 is reduced by the deflecting element 113 in the direction transverse to the insertion direction ESR. The deflecting element 113 is shaped like a wedge, such that the interior cross section Q decreases along the deflecting element 113 in the insertion direction ESR.

FIG. 3 shows an exemplary structure for the air filter assembly 1 for an air conditioner. The air filter assembly 1 comprises an air path 2 for air L that flows through it in the flow direction S. The air filter assembly 1 also comprises an ionizer 3 in the air path 2 for generating ions therein. The ionizer 2 contains numerous discharge electrodes 6 and counter electrodes 7, which are downstream of the discharge electrodes 6 in the air path.

The air filter assembly 1 also contains an air filter 100 obtained with the invention downstream of the ionizer 3 in the flow direction S of the air path 2.

Each discharge electrode 6 comprises an electrode rod 12 from which numerous needle-shaped electrode tips 9 protrude, which can generate the ions for charging particles. The discharge electrodes 6 are transverse to the flow direction S and spaced apart. The individual electrode tips 9 each protrude away from the electrode rods 12 counter to the flow direction S.

As FIG. 3 shows, the electrode tips 9 can be arranged in a grid in the air path 2, and taper conically away from the electrode rods 12. The discharge electrodes 6 can be made of steel, e.g. stainless steel. The individual electrode rods 12 extend in a straight line in the same direction E in the air path 2, which is orthogonal to the flow direction S.

The air filter assembly 1 also comprises a high voltage source 8 with an electrical pole 8a and counter pole 8b for generating a high voltage HV, which is between 5 kV and 15 kV in this example, between the pole 8a and counter pole 8b.

The electrical pole 8a is negative in this example, and the counter pole is positive in the high voltage source 8. The pole 8a could also be the positive pole, and the counter pole 8b could be the negative pole in the high voltage source 8 (not shown). The pole 8a is connected by a wire 4 to the discharge electrodes 6 in the ionizer 3. The counter pole 8b is connected to the counter electrodes 7 in the ionizer and the conductive layer 103 in the air filter 100 by a wire 55. In another version, the counter electrodes 7 and conductive layer 103 are connected to the counter pole 8b, and the discharge electrodes 6 are connected to the pole 8a. The counter electrodes 7 are formed by electrode plates 11, which are between two adjacent discharge electrodes 6. The discharge electrodes 6 and electrode plates 11 can thus alternate in the direction transverse to the flow direction S.

The electric counter pole 8b in FIG. 3 is connected to the terminal 106 by a connecting wire 122, e.g. an electrical cable 123. The connecting wire 122, or cable 123, is bonded to the terminal 106 on the air filter 100, e.g. with a soldered connection 124. Instead of soldering, brazing or crimping can also be used to obtain the bond.

As FIG. 3 shows, there can be switch 10 between the terminal 106 and the counter pole 8b for disconnecting the two from one another.

The subject specification can be readily understood with reference to the following Numbered Paragraphs:

Numbered Paragraph 1. An air filter (100) for an air filter assembly (1) in an air conditioner, in particular for filtering out particles, preferably pollutants, from air (L), which has
a filter element (101) with an electrically conductive layer (103), which is preferably at least partially on an outer surface (102) of the filter element (101), and
a housing (104), which partially encompasses a housing interior (105) into which the filter element (101) is inserted,
wherein the air filter (100) has a terminal (106) on the housing (104) that can be contacted from outside the housing interior (105), which is made of an electrically conductive material and is connected to the conductive layer (103) on the filter element (101).

Numbered Paragraph 2. The air filter according to Numbered Paragraph 1, characterized in that
the filter element (101) contains at least one filter layer (119) through which air can flow, for filtering particles out of the air (L), and
the conductive layer (103) is placed on the filter layer (119) or on a separate substrate (119), in particular a substrate other than that for the filter element (101).

Numbered Paragraph 3. The air filter according to Numbered Paragraph 1 or 2, characterized in that the conductive layer (103) forms an outer surface (102) of the filter element (101) that the terminal (106) bears on.

Numbered Paragraph 4. The air filter according to any of the Numbered Paragraphs 1 to 3, characterized in that the terminal (106) is a spring component, preferably in the form of a leaf spring.

Numbered Paragraph 5. The air filter according to any of the preceding Numbered Paragraphs, characterized in that the terminal (106), or spring component, is made of steel, in particular spring steel.

Numbered Paragraph 6. The air filter according to any of the preceding Numbered Paragraphs, characterized in that the terminal (106) is tensioned against the filter element (101).

Numbered Paragraph 7. The air filter according to any of the preceding Numbered Paragraphs, characterized in that
the terminal is attached to the housing (104), and/or
the terminal (106) at least partially seals an opening (111) in the housing (104), and/or

Numbered Paragraph 8. The air filter according to any of the preceding Numbered Paragraphs, characterized in that the filter element (101) contains a filtering medium (107) in the form of a pleated bellows (108) with numerous pleats (109), on which the conductive layer (103) is placed, and the terminal (106) bears on at least one pleat (109), in particular the peak (118) of this pleat (109) contained in the bellows (108).

Numbered Paragraph 9. The air filter according to any of the preceding Numbered Paragraphs, characterized in that the filtering medium (107) contains a filter material (110) designed to filter out particles, in particular aerosols, preferably with a diameter of 50 nm to 2.5 μm.

Numbered Paragraph 10. The air filter according to any of the preceding Numbered Paragraphs, characterized in that the conductive layer (103) contains activated carbon or is made of activated carbon.

Numbered Paragraph 11. The air filter according to any of the preceding Numbered Paragraphs, characterized in that
there is an opening (112) in the housing for inserting the filter element into the housing interior (105), and
there is a deflecting element (113) in the housing interior (105) with which the filter element (101) is pressed against the terminal (106) when it is slid into the housing interior (105).

Numbered Paragraph 12. The air filter according to any of the preceding Numbered Paragraphs, characterized in that
the filter element (101) can be slid in the insertion direction (ESR) into the housing interior (105), and
the inner cross section (Q) of the housing interior (105) is reduced by the deflecting element (113) in a direction transverse to the insertion direction (ESR).

Numbered Paragraph 13. The air filter according to Numbered Paragraph 10 or 11, characterized in that the deflecting element (113) forms a wedge.

Numbered Paragraph 14. The air filter according to any of the Numbered Paragraphs 10 to 12, characterized in that the deflecting element (113) is attached to the housing (104) or forms an integral part of the housing (104).

Numbered Paragraph 15. The air filter according to any of the Numbered Paragraphs 10 to 13, characterized in that the internal cross section (Q) decreases in the insertion direction (ESR) along the deflecting element (113).

Numbered Paragraph 16. An air filter assembly (1) for an air conditioner, in particular for filtering out particles, preferably pollutants, from air (L), which has
an air path (2) through which air (L) can flow in a flow direction (S),
an ionizer (3) for generating ions in the air path (2), which contains at least one discharge electrode (6) and at least one counter electrode (7),
an air filter (100) according to any of the preceding Numbered Paragraphs, placed in the air path upstream of the ionizer (3) in the flow direction (S),
a high voltage source (8) containing an electric pole (8a) and counter pole (8b), for generating a high voltage (HV), in particular between 5 kV and 15 kV, between the pole (8a) and counter pole (8b),
wherein the pole (8a) is electrically connected to the at least one discharge electrode (6) in the ionizer (3), and the counter pole (8b) is electrically connected to at least one counter electrode (7) in the ionizer and the conductive layer (103) on the air filter (100).

Numbered Paragraph 17. The air filter assembly according to Numbered Paragraph 15, characterized in that at least three discharge electrodes (6) and two electrode plates (11) alternate in a direction transverse to the flow direction (S).

Numbered Paragraph 18. The air filter assembly according to Numbered Paragraph 15 or 16, characterized in that
the electric counter pole (8b) is connected to the terminal (106) by a wire (122), in particular in the form of an electrical cable (123), and
the wire (122) or cable (123) is bonded to the terminal (106) on the air filter (100), in particular by soldering, brazing, or crimping.

Numbered Paragraph 19. The air filter assembly according to Numbered Paragraph 15 or 16, characterized in that there is a switch (10) between the terminal (106) and the counter pole (8b) for disconnecting the terminal (106) from the counter pole (8b).

Numbered Paragraph 20. The air filter assembly according to any of the Numbered Paragraphs 15 to 17, characterized in that
the electric pole (8a) is negative, and the counter pole forms the counter potential for the high voltage source (8), or
the electric pole (8a) is positive, and the counter pole forms the counter potential for the high voltage source (8).

1-20. (canceled)

21. An air filter for an air filter assembly in an air conditioner, in particular for filtering out particles, preferably pollutants, from air, comprising:
a filter element with an electrically conductive layer, the filter element disposed least partially on an outer surface of the filter element, and
a housing, which partially encompasses a housing interior into which the filter element is inserted,
wherein the air filter has a terminal on the housing that is configured to be contacted from outside the housing interior, the terminal comprises an electrically conductive material and is connected to the conductive layer on the filter element.

22. The air filter according to claim 21, wherein
the filter element comprises at least one filter layer through which air can flow, and is configured to filter particles out of the air, and
the conductive layer is disposed upon the filter layer or upon a separate substrate, that is other than that for the filter element.

23. The air filter according to claim 21, wherein the conductive layer establishes an outer surface of the filter element that the terminal bears on.

24. The air filter according to claim 21, wherein the terminal is a spring component.

25. The air filter according to claim 21, wherein one of the terminal, or spring component, is made of steel.

26. The air filter according to claim 21, wherein the terminal is tensioned against the filter element.

27. The air filter according to claim 21, wherein
the terminal is attached to the housing, and/or
the terminal at least partially seals an opening in the housing, and/or

28. The air filter according to claim 21, wherein the filter element comprises a filtering medium in the form of a pleated bellows with a plurality of pleats, on which the conductive layer is placed, and the terminal bears on at least one pleat that is a pleat at the peak of the plurality of pleats contained in the bellows.

29. The air filter according to claim 21, wherein the filtering medium comprises a filter material that is configured to filter out particles, in particular aerosols, preferably with a diameter of 50 nm to 2.5 μm.

30. The air filter according to claim 21, wherein the conductive layer comprises activated carbon or is formed from activated carbon.

31. The air filter according to claim 21, further comprising
an opening in the housing that is configured inserting the filter element into the housing interior, and
a deflecting element in the housing interior with which the filter element is pressed against the terminal when the filter element is inserted into the housing interior.

32. The air filter according to claim 21, wherein
the filter element is configured to be inserted in the insertion direction into the housing interior, and
the inner cross section of the housing interior is reduced by the deflecting element in a direction transverse to the insertion direction.

33. The air filter according to claim 31, wherein the deflecting element forms a wedge.

34. The air filter according to claim 31, wherein the deflecting element is attached to the housing or establishes an integral part of the housing.

35. The air filter according to claim 31, wherein an in(ternal cross section decreases in an insertion direction along the deflecting element.

36. An air filter assembly for an air conditioner, in particular for filtering out particles, preferably pollutants, from air, comprising:
an air path through which air is configured to flow in a flow direction,
an ionizer configured for generating ions in the air path, the ionizer comprises at least one discharge electrode and at least one counter electrode,
an air filter according to claim 21, placed in the air path at a position that is upstream of the ionizer in the flow direction,
a high voltage source comprising an electric pole and counter pole, the high voltage source is configured generating a high voltage, in particular between 5 kV and 15 kV, between the pole and counter pole,
wherein the pole is electrically connected to the at least one discharge electrode in the ionizer, and the counter pole is electrically connected to at least one counter electrode in the ionizer and the conductive layer on the air filter.

37. The air filter assembly according to claim 36, wherein the at least one discharge electrode is at least three discharge electrodes, wherein the at least three discharge electrodes and two electrode plates alternate in a direction transverse to the flow direction.

38. The air filter assembly according to claim 36, wherein
the electric counter pole is connected to the terminal with a wire or an electrical cable, and
the wire or cable is bonded to the terminal on the air filter by soldering, brazing, or crimping.

39. The air filter assembly according to claim 36, further comprising a switch between the terminal and the counter pole that is configured for disconnecting the terminal from the counter pole.

40. The air filter assembly according to claim 36, wherein
when the electric pole is at a negative potential the counter pole forms the counter potential for the high voltage source, or
the electric pole is at a positive potential the counter pole forms the counter potential for the high voltage source.
